(19) United States
(12) Patent Application Publication
(10) Pub. No.: US 2009/0120301 A1
(43) Pub. Date: May 14, 2009

(54) Cooking Device

(76) Inventor: Teri L. Severnak, West Jordan, UT (US)

Correspondence Address: ADVANTIA LAW GROUP, 9035 SOUTH 1300 EAST, SUITE 200, SANDY, UT, 84094, US

(21) Appl. No.: 11/938,461

(22) Filed: Nov. 12, 2007

(51) Int. Cl. A47J 43/04; A47J 27/00

(52) U.S. Cl. 99/331; 99/348; 99/342

(57) ABSTRACT

A cooking device for making candy. The device includes: a U-shaped base member, a heating module, a container, a mixing module, a temperature indictor module, and a control module. The heating module includes a heating surface coupled to an interior surface of a first arm of the U-shaped base member. The container contains ingredients. The mixing module mixes ingredients in the container. The temperature indictor module indicates a temperature. The control module includes a heating temperature control module, and a mixing speed control module. The heating temperature control module controls a temperature of the heating module. The mixing speed control module controls a speed of the mixing module. A second arm of the U-shaped base member is hingedly coupled to the U-shaped base member member.

### BACKGROUND OF THE INVENTION

1. Field of the Invention

The present invention relates to cooking devices, specifically an automated cooking and stirring device for making candy.

2. Description of the Related Art

Individuals generally use automated cooking and stirring devices to make candy, such as caramel, or toffee. Automated cooking devices typically have a mixing arm, a temperature control, and a timing mechanism. However, a need exists for a cooking device that is more versatile, convenient, durable and multi-functional which further meets the needs of users. Some improvements have been made in the field. Examples include but are not limited to the references described below, which references are incorporated by reference herein:

U.S. Pat. No. 3,589,834, issued to Cairelli, discloses a food mixer having parallel shafts with integral helical intermeshing blades on each shaft. Also extending from the housing of the food mixer, is a heating device which is used in conjunction with the helical blades of the mixer.

U.S. Pat. No. 5,368,384, issued to Duncan, et al., discloses a hand-held mixing device comprising an electric motor, an elongated shaft extending from the motor, a housing enclosing the motor and a major portion of the shaft, a blade at the free end of the shaft, a heating element extending from the housing, the heating element formed to have at least one coil surrounding the blade, the coil being dimensioned to be spaced from the outer edge of the blade and to form a generally annular gap thereabout. The motor and heating element are electrically connectable to an electrical power source wherein the electrical power to the motor and to the heating element are independently controllable.

U.S. Pat. No. 5,228,381, issued to Virgilio, et al., discloses a food cooker that is provided including a base provided with a heating plate and a temperature sensing element connected to temperature control devices. The sensing element is mounted on a sliding support so as to be maintained in contact with a bottom part of the pot. Provided inside the pot is a food stirring vane which is mounted in a rotating support driven from a motor located in the base. A vertical shaft extends upwardly through the center of the pot. Rotation of the shaft effects rotation of the support. The stirring vane receives rotational movement about an axis of the shaft from the support and receives further rotational movement about an axis passing through the vane by a gearing between the vane and the support.

U.S. Pat. No. 6,629,491, issued to Chan, discloses a cooking appliance that includes a cooking vessel to receive ingredients to be heated, stirred and cooked, an electric heater associated with the cooking vessel to heat the ingredients, and a drive motor and stirring blade. The appliance also includes provision for maintaining a tilted configuration of the cooking vessel during cooking and stirring. The appliance is particularly suited to unattended cooking of stir-fry and also for stirring of sauces and soup.

U.S. Pat. No. 5,438,758, issued to Roth-White, discloses a heated knife comprising a handle; a cutting blade formed of a thermally conductive material having a tip end and a base end with the base end coupled to the handle; a heating element formed of a thermally conductive material disposed within the cutting blade with a portion thereof extended from the base end of the cutting blade; a power source coupled to the handle with the power source adapted to energize the heating element; and a switch coupled between the heating element and the power source and connected to the handle with the switch having one orientation for de-energizing the heating element and another orientation for energizing the heating element, whereby allowing the cutting blade to be heated.

U.S. Design Pat. No. 286,258, issued to Grange, discloses an ornamental design for a food mixer.

The inventions heretofore known suffer from a number of disadvantages which may include being limited in applicability, unduly complex, inconvenient, limited adjustability, difficult to clean and/or maintain, and/or otherwise lack the means for performing a constant and consistent heating and mixing function.

What is needed is a candy cooking device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available cooking devices. Accordingly, the present invention has been developed to provide a cooking device for making candy.

There is one embodiment of a cooking device for making candy. The device may include: a U-shaped base member; a heating module that may be coupled to the base member, and may include a heating surface that may be coupled to an interior surface of a first arm of the U-shaped base member; a container that may be coupled to the heating surface opposite the U-shaped base member and/or may extend upwardly therefrom, and/or may be configured to contain ingredients; a mixing module that may be coupled to the base member, and/or may include a mixing arm that may be removably coupled to an interior surface of the mixing module and/or may extend downwardly therefrom, the mixing arm may be disposed substantially within the container, and/or may be configured to mix ingredients in the container; and/or a temperature indictor module that may be coupled to the mixing module, and/or may be configured to indicate a temperature.

According to one embodiment of the invention, the temperature indicator module may be disposed within a center of the mixing arm. In another embodiment of the invention, a control module may include: a heating temperature control module that may be in communication with the heating module, and/or configured to control a temperature of the heating module; and/or a mixing speed control module that may be in communication with the mixing module, and/or configured to control a speed of the mixing module. In yet another embodiment of the invention, the second arm of the U-shaped base member may be hingedly coupled to the U-shaped base member member.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawings, in which:

FIG. 1 illustrates a front isometric view of a cooking device 10 for making candy, according to one embodiment; and

FIG. 2 illustrates a block diagram of a cooking device 10 for making candy, according to one embodiment.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

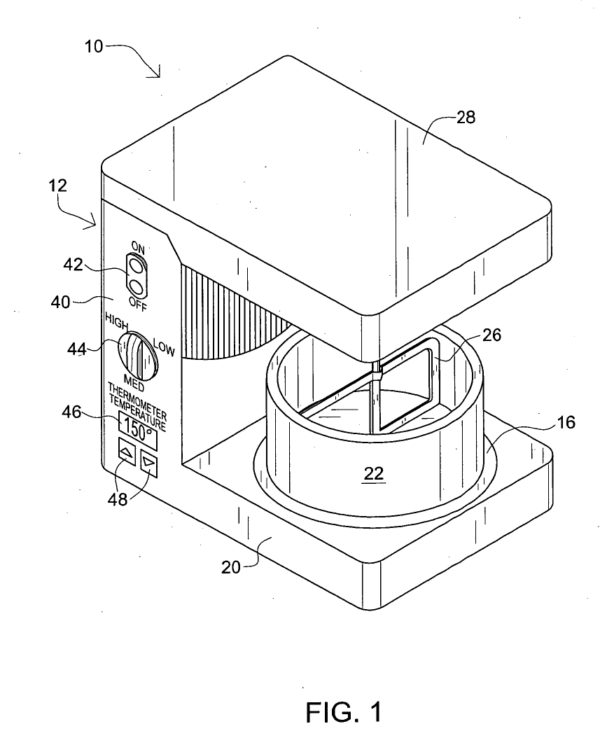

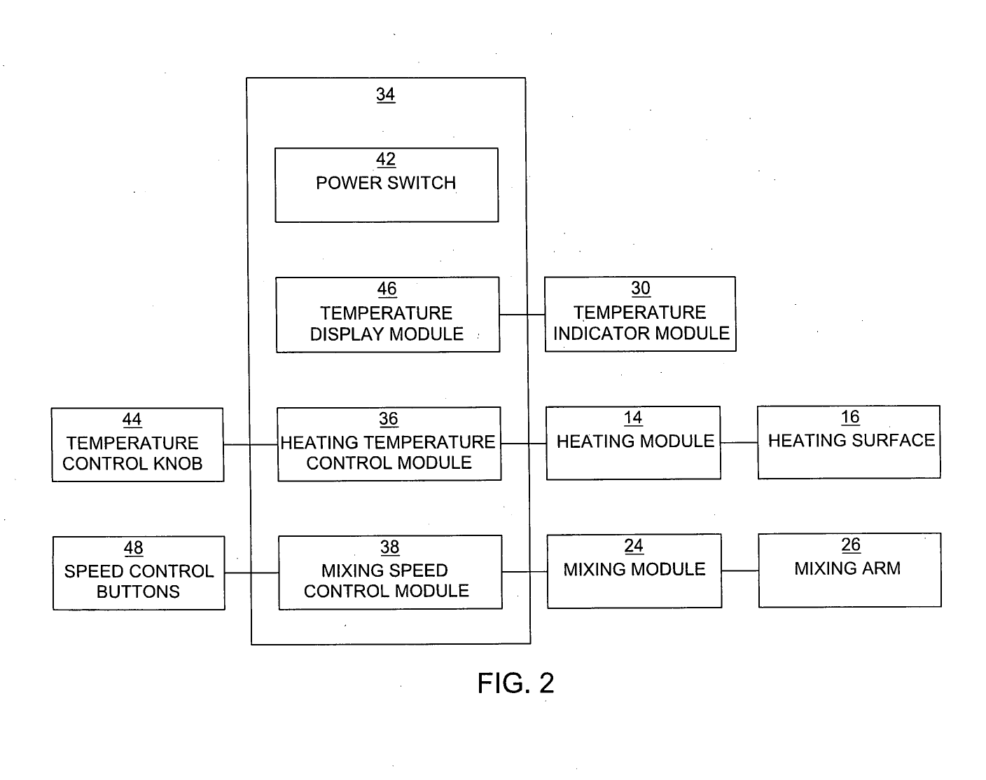

Referring to FIGS. 1 and 2 a cooking device 10 for making candy will hereafter be described. FIG. 1 illustrates a front isometric view of a cooking device 10 for making candy, according to one embodiment. FIG. 2 illustrates a block diagram of a cooking device 10 for making candy, according to one embodiment.

As shown, the device 10 generally includes: a U-shaped base member 12; a heating module 14, a container 22, a mixing module 24; a temperature indictor module 30 and a control module 34. The U-shaped base member 12 provides structure wherein and upon all the components of the device 10 are attached. The U-shaped base member 12 includes a main body 40, a first arm 20 and a second arm 28. The main body 40 is a structure that is vertically oriented. The first arm 20 extends, as a continuous whole, horizontally from a lower portion of the main body 40. The second arm 28 extends horizontally from an upper portion of the main body 40. The first arm 20 is directly below the second arm 28. The second arm 28 is hingedly coupled to the main body 40 of the U-shaped base member 12 so as to be able to articulate from a horizontal position to a vertical position.

The heating module 14 is coupled interior to the first arm 20 of the U-shaped base member 12. The heating module 14 includes a heating surface 16 which is adjacent thereto and coupled to an interior surface of the first arm 20 of the U-shaped base member 12. The heating surface 16 is recessed just below a top most horizontal surface of the first arm 20. The heating surface 16 is in thermal communication with the heating module 14. In one embodiment the heating surface 16 is shaped as a thin disk and is composed of a thermally conductive material.

As shown, the container 22 is coupled to a top portion of the heating surface 16. The container 22 has a cylindrical shape; a base portion thereof has a diameter that is nearly equal to the diameter of the heating surface 16. From the base portion thereof the container 22 extends uniformly upwardly therefrom so as to be an open container; such that food ingredients may easily be disposed therein. The container 22 is composed of a thermally conductive material; and the material is rigid.

The mixing module 24 is coupled interior to the U-shaped base member 12. The mixing module 24 includes a mixing arm 26 which is removably couplable to an interior surface thereof. The mixing arm 26 is in mechanical communication with the mixing module 24. The mixing arm 26 extends orthogonally from the second arm 28 of the U-shaped base member 12. When the second arm 28 is disposed horizontally the mixing arm 26 extends downwardly therefrom and is disposed substantially within the container 22, so as to reach an interior bottom surface and interior side surfaces thereof. The mixing arm 26 is composed of rigid material where a least a portion thereof is composed of thermally conductive material. An example of a mixing speed control module, mixing module and mixing arm includes components of a Ultra Power Plus Hand Mixer—KHM7TOB by KitchenAid at www.kitchenaid.com.

The temperature indictor module 30 is coupled to the mixing module 24. According to one embodiment, a portion of the temperature indicator module 30 is disposed within a center portion of the mixing arm 26. The temperature indicator module 30 nearly extends through the entire length of the mixing arm 26, so as to measure the temperature near the bottom portion of the container 22. The temperature indicator module 30 senses the temperature in the container 22 and indicates the temperature therein. An example of a temperature indicator module includes the MICROCOIL™ from Watlow Electric Manufacturing Company 12001 Lackland Road, St. Louis, Mo., USA 63146.

As illustrated, the control module 34 is disposed interior to the main body 40 of the U-shaped base member 12. The control module 34 includes: a heating temperature control module 36, a mixing speed control module 38, a power switch 42 and a temperature display module 46. The heating temperature control module 36 is in electronic communication with the heating module 14 so as to control the heating modules 14 temperature. The heating temperature control module 36 includes a temperature control knob 44. The temperature control knob 44 is in electronic communication with the heating temperature control module 36 so that a user may control the temperature of the heating module 14. The temperature control knob 44 is adjustably rotatable between a low temperature setting and a high temperature setting so that the user may define a desired temperature of the heating module 14. An example of a temperature control knob includes a EUP1100 potentiometer from www.potentionmeter.com. An example of a heating temperature control module, heating module and heating surface is found in U.S. Pat. No. 6,380,521 which discloses a kitchen appliance with improved heating element control.

The mixing speed control module 38 is in electronic communication with the mixing module 24 so as to control the mixing modules 24 rotational speed. The mixing speed control module 38 includes speed control buttons 48. The speed control buttons 48 are in electronic communication with the mixing speed control module 38 so that a user may control the rotational speed of the mixing arm 26 of the mixing module 24. The speed control buttons 48 includes one button that increases the rotational speed and another button that decreases the rotational speed of the mixing arm 26 of the mixing module 24.

The power switch 42 is in electric communication between the control module 34 and a power source, such as an A/C power outlet. The power switch 42 is a toggle switch which has two possible positions; one position allowing the flow of power to the cooking device 10 via the control module 34, another position mitigating the flow of power thereto. An example of a power switch includes an ARN—Rocker Switch from DNA Group, Inc. P.O. Box 31727, Raleigh, N.C. (USA) 27622.

According to one embodiment, the temperature display module 46 is an LCD display unit which indicates the current temperature of the material that may be contained in the container 22. The temperature display module 46 is in electronic communication with the control module 34, which is in electronic communication with the temperature indicator module 30. In one embodiment, the temperature display module 46 displays numeric indicators and a symbolic indicator to apprise the user of the temperature and the units thereof: Fahrenheit or Celsius. An example of an LCD display unit includes an LC2022 from Densitron Corporation 10400-4 Pioneer Blvd, Santa Fe Springs, Calif. USA 90670.

In operation of the illustrated embodiment, a user may turn “on” the cooking device 10 by toggling the power switch 42 to the “on” position. A user may swing the second arm 28 of the U-shaped base member 12 to a vertical position so as to add or remove the mixing arm 26 thereto, and/or add or remove the container 22 from its position on the heating surface 16. A user may add or remove material to the container 22 while the container 22 is, or is not, disposed upon the heating surface 16. A user may position the second arm 28 in a horizontal position so that the mixing arm 26 is disposed into the container 22 and a user may increase or decrease the rotational speed of the mixing arm 26 by pressing the speed control buttons 48. A user may increase or decrease the temperature of the heating surface 16 by rotating the temperature control knob 44 to a desired position that may achieve the desired heating.

Embodiments of cooking device 10 fulfill a need for a more versatile, convenient, durable and multi-functional cooking device 10 for automated cooking and stirring of candy. Further the cooking device 10 provides a convenient, adjustable, simple to clean and maintain, cooking device 10 which effectively and efficiently provides means for performing a constant and consistent heating and mixing function for cooking.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the U-shaped base member 12 is illustrated to be shaped in a certain fashion, it is envisioned that it may take alternative shapes which fulfill the need of housing the components and modules of the present invention. It is envisioned that the size of the components may be varied. For example the cooking device 10 may have a smaller size to suit the needs for home use, alternatively it may be sized larger so as to suit commercial uses.

Additionally, although the figures illustrate the power switch 42, the temperature control knob 44, the temperature display module, and the speed control buttons 48 to be in specific positions relative to each other, it is envisioned that they may be positioned in and oriented in any arrangement so as to fulfill their intended function and meet the needs of the user. Although the mixing arm 26 is shown to be shaped in a certain fashion it is envisioned that the mixing arm 26 may have alternative shapes so as to meet specific needs for mixing of specific materials.

Finally, it is envisioned that the components of the device may be constructed of a variety of materials, including: plastics such as acrylic, polypropylene, polyester, polyethylene, nylon, silicone plastics, nitrile and/or various synthetic and/or natural rubbers and/or glass filled plastics; metals including spring steel and/or other steels, aluminum, and/or titanium; glass and/or other stone and/or composites thereof; and/or composite materials such as carbon-fiber and/or fiberglass.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A cooking device for making candy, comprising:
a) a U-shaped base member;
b) a heating module, coupled to the base member, including a heating surface coupled to an interior surface of a first arm of the U-shaped base member;
c) a container, coupled to the heating surface opposite the U-shaped base member and extending upwardly therefrom, configured to contain ingredients;
d) a mixing module, coupled to the base member, including a mixing arm removably coupled to an interior surface of the mixing module and extending downwardly therefrom, the mixing arm being disposed substantially within the container, and configured to mix ingredients in the container; and
e) a temperature indictor module, coupled to the mixing module, configured to indicate a temperature.

2. The cooking device of claim 1, wherein the temperature indicator module is disposed within a center of the mixing arm.

3. The cooking device of claim 2, further comprising a control module, including:
a) a heating temperature control module, in communication with the heating module, configured to control a temperature of the heating module; and
b) a mixing speed control module, in communication with the mixing module, configured to control a speed of the mixing module.

4. The cooking device of claim 3, wherein the second arm of the U-shaped base member member is hingedly coupled to the U-shaped base member.

5. A cooking device for making candy, consisting essentially of:
a) a U-shaped base member;
b) a heating module, coupled to the base member, including a heating surface coupled to an interior surface of a first arm of the U-shaped base member;
c) a container, coupled to the heating surface opposite the U-shaped base member and extending upwardly therefrom, configured to contain ingredients;
d) a mixing module, coupled to the base member, including a mixing arm removably coupled to an interior surface of the mixing module and extending downwardly therefrom, the mixing arm being disposed substantially within the container, and configured to mix ingredients in the container; and
e) a temperature indictor module, coupled to the mixing module, configured to indicate a temperature.

6. The cooking device of claim 5, wherein the temperature indicator module is disposed within a center of the mixing arm.

7. The cooking device of claim 6, wherein the second arm of the U-shaped base member is hingedly coupled to the U-shaped base member member.
